(19) United States
(12) Patent Application Publication
(10) Pub. No.: US 2026/0225633 A1
(43) Pub. Date: Aug. 6, 2026

(54) VEHICLE SYSTEM AND METHOD

(71) Applicant: Transportation IP Holdings, LLC, Norwalk, CT (US)

(72) Inventor: Tod James Stevens, Tarragindi (AU)

(73) Assignee: Transportation IP Holdings, LLC, Norwalk, CT (US)

(21) Appl. No.: 18/968,833

(22) Filed: Dec. 4, 2024

(51) Int. Cl. B61L 27/16; B60L 5/00; B60L 15/20; B60L 15/32; B60L 50/40; B60L 50/53; B60L 55/00; B61C 3/00; B61C 5/00

(52) U.S. Cl. CPC B61L 27/16; B60L 15/2045; B60L 15/32; B60L 50/40; B60L 50/53; B60L 55/00; B60L 5/00; B60L 2200/26; B60L 2240/12; B61C 3/00; B61C 5/00

(57) ABSTRACT

A vehicle system and method are disclosed. An example vehicle system may include at least one battery electric vehicle, a conductive circuit, an electric motor, and a control circuit. The conductive circuit is capable of transmitting electric energy between the at least one battery electric vehicle and an external power source during movement of the vehicle system. The electric motor is capable of propelling the at least one battery electric vehicle using electric energy from the external power source. The control circuit controls movement of the vehicle system along a route according to a trip plan. The trip plan comprises operational settings. The operational settings comprise a power draw setting corresponding to a power draw of the vehicle system from the external power source as a function of a location of the vehicle system on the route.

### BACKGROUND

### Technical Field

Various aspects of the present disclosure relate to controlling power draw by one or more vehicle systems from an external power source.

### Discussion of Art

Vehicle systems may receive power from an external power source during movement. For example, some rail vehicle may include a conductive circuit (e.g., a current collector, a rail shoe) for transmitting electrical power between the rail vehicle and a power grid as the rail vehicle travels along a route.

The load on the external power source can vary over time based on the operation of the vehicle systems. For example, the power drawn by a single vehicle system can vary depending on factors such as the tractive effort expended to propel the vehicle system, the terrain of the route traveled by the vehicle system, and whether or not the vehicle system is located along a portion of the route where power transmission with the external power source is possible. The load variation on the external power source can be further compounded when multiple vehicle systems are traveling on routes capable of power transmission with the external power source.

The cost of drawing power from the external power source may vary based on the load imposed on the external power source by the vehicle systems. For example, a utility provider supplying electric power to a grid may charge a higher rate for power when the demand for power is higher. Accordingly, the cost of power can increase significantly when multiple vehicles systems are drawing power from the external power source at the same time.

### BRIEF DESCRIPTION

In one or more embodiments, a vehicle system including at least one battery electric vehicle is provided. The vehicle system includes a conductive circuit, an electric motor, and a control circuit. The conductive circuit is capable of transmitting electric energy between the at least one battery electric vehicle and an external power source during movement of the vehicle system. The electric motor is capable of propelling the at least one battery electric vehicle using electric energy from the external power source. The control circuit controls movement of the vehicle system along a route according to a trip plan. The trip plan comprises operational settings. The operational settings comprise a power draw setting corresponding to a power draw of the vehicle system from the external power source as a function of a location of the vehicle system on the route.

In one or more embodiments, a method for coordinating movement of a plurality of vehicle systems is provided. At least one vehicle in each of the plurality of vehicle systems may include a battery electric locomotive capable of receiving electric energy from an external power source during movement of the at least one vehicle system. The method includes receiving, by a control circuit, a plurality of trip plans corresponding to the plurality of vehicle systems. Each trip plan of the plurality of trip plans comprises a planned movement of the corresponding vehicle system along a route. The method further includes predicting, by the control circuit, an expected load on the external power source as a function of time based at least in part on the plurality of trip plans. The control circuit can cause a modification of a trip plan of the plurality of trip plans based at least in part on the expected load on the external power source.

In one or more embodiments, a vehicle system including a battery electric vehicle and a combustion engine vehicle is disclosed. The vehicle system includes a conductive circuit, an electric motor, a combustion engine, and a control circuit. The conductive circuit is capable of transmitting electric energy between the battery electric vehicle and an electric power network during movement of the vehicle system. The electric motor is capable of propelling the battery electric vehicle using electric energy from the electric power network. The combustion engine is capable of propelling the combustion engine vehicle. The control circuit controls movement of the vehicle system along a route according to a trip plan. The control circuit can modify the trip plan as a function of the location of the vehicle system on the route to adjust a planned power transmission between the battery electric vehicle and an electric power network as the vehicle system moves along the route.

### BRIEF DESCRIPTION OF THE DRAWINGS

Reference is made to the accompanying drawings in which similar components are indicated using the same reference numbers, and in which:

FIG. 1 illustrates a vehicle system, according to one embodiment.

FIG. 2 is a schematic illustration of a vehicle control system, according to one embodiment.

FIG. 3 is a schematic illustration of propulsion system, according to one embodiment.

FIG. 4 is a schematic illustration of another propulsion system, according to one embodiment.

FIG. 5 is a schematic illustration of another propulsion system, according to one embodiment.

FIG. 6 is a schematic illustration of a vehicle management system, according to one embodiment.

FIGS. 7A-7D illustrate a vehicle system moving along a route according to a trip plan, according to one embodiment.

FIG. 8 is a plot of a power draw of a vehicle system from an external power source as a function of a location of the vehicle system on a route, according to one embodiment.

FIG. 9 is a plot of a power return of a vehicle system to an external power source as a function of a location of the vehicle system on a route, according to one embodiment.

FIG. 10 is a plot of tractive effort of different propulsion sources a vehicle system as a function of a location of the vehicle system on a route, according to one embodiment.

FIGS. 11A-11C illustrate a plurality of vehicle systems moving along one or more routes according to panned movements and/or operations from a vehicle management system, according to one embodiment.

FIG. 12 illustrates a flow diagram of a method for coordinating movement of a plurality of vehicle systems, according to one embodiment.

### DETAILED DESCRIPTION

Various aspects of the present disclosure relate to controlling and/or managing power draw by one or more vehicle systems from an external power source. The power drawn by one or more vehicle systems from the external power source may be controlled to achieve an operational objective. Suitable operational objective may include preventing instances a where the one or more vehicle systems draw a high magnitude of power from the external power source at a given time (e.g., avoiding a peak load) or minimizing the total amount of power a vehicle system draws from the external power source over the course of a trip. The power draw of the one or more vehicle systems may be controlled by a vehicle control system using a trip plan that designates operational settings of the vehicle system(s) while moving along a route. The power draw of multiple vehicle systems from the external power source may be managed by a vehicle management system that analyzes the planned movement and/or operation of the vehicle systems to predict an expected power draw from the external power source and causes changes to the planned movement and/or operation of the vehicle systems.

In one embodiment, a vehicle system including at least one battery electric vehicle is provided. The vehicle system includes a conductive circuit for transmitting electric energy between the at least one battery electric vehicle and an external power source. The vehicle system further includes an electric motor that can propel the at least one battery electric vehicle using electric energy from the external power source. The vehicle system further includes a control circuit to control movement of the vehicle system along a route according to a trip plan. The trip plan comprises operational settings. The operational settings may include a power draw setting corresponding to a power draw of the vehicle system from the external power source as a function of a location of the vehicle system on the route.

For example, the power draw setting may designate locations along the route where the vehicle system is to draw power from the external power source and locations along the route where the vehicle system is not to draw power from the external power source. The trip plan and/or the power draw setting may be implemented to control a total power draw of the vehicle system from the external power source as the vehicle system moves along the route. The trip plan and/or the power draw setting may be implemented to control a peak power draw of the vehicle system from the external power source as the vehicle system moves along the route.

The operational settings may include a power return setting. The vehicle system may include a regenerative circuit coupled to the conductive circuit. The regenerative circuit may be capable of generating electrical power from other forms of energy produced by the movement of the vehicle system (e.g., regenerative braking). The power return setting can control the transmission of power (e.g., generated by the regenerative circuit) from the vehicle system to the external power source as a function of the location of the vehicle system on the route. For example, the power return setting may designate locations along the route where the vehicle system is to transmit power to external power source and locations along the route where the vehicle system is not to transmit power to the external power source.

The operational settings may include a power source setting. The vehicle system may include an energy storage device (e.g., a battery). The power source setting can control whether to operate the electric motor using electric energy from the energy storage device, using electric energy from the external power source, or using a combination of energy from the energy storage device and the external power source. For example, the power source setting may designate locations along the route where the vehicle system is to operate the electric motor using electric energy from energy storage device and locations along the route where the vehicle system is to operate the electric motor using electric energy from the external power source. In some examples, the power source setting may designate locations along the route where the vehicle system is to operate the electric motor using electric energy from energy storage device based on a corresponding power requirement of the electric motor exceeding a power requirement threshold.

The operational settings may include a propulsion source setting. For example, the vehicle system of may include a combustion engine vehicle to propel the vehicle system using combustion. The propulsion source setting can control whether to propel the vehicle system using the electric motor, the combustion engine, or a combination of the electric motor and the combustion engine as a function of the location of the vehicle system on the route. The propulsion source setting may further designate a relative tractive effort to be exerted by each of the electric motor and the combustion engine as a function of the location of the vehicle system on the route. In some examples, the power source setting may designate locations along the route where the vehicle system is to operate the combustion engine to maintain a power requirement of the electric motor below a power requirement threshold.

The external power source may include a power grid (e.g., an electric power network), and the conductive circuit of the vehicle system may include a current collector for transmitting electric energy between the vehicle system and a catenary connected to the power grid.

In one embodiment, a vehicle management system is disclosed. The vehicle management system may include a control circuit. The control circuit may receive a plurality of trip plans corresponding to the plurality of vehicle systems. Each trip plan of the plurality of trip plans may include a planned movement of the corresponding vehicle system along a route. The control circuit may predict an expected load on the external power source as a function of time based at least in part on the plurality of trip plans. For example, the control circuit may determine and expected peak load on the external power source for a particular future time period and may further determine that the expected peak load exceeds a peak load threshold. The control circuit may cause a modification of at least one of the trip plans to prevent the load on the external power source from exceeding the peak load threshold. The modification to the at least one trip plan may include changing a planned movement of at least one of the vehicle systems and/or changing a power draw setting for at least one of the vehicle systems.

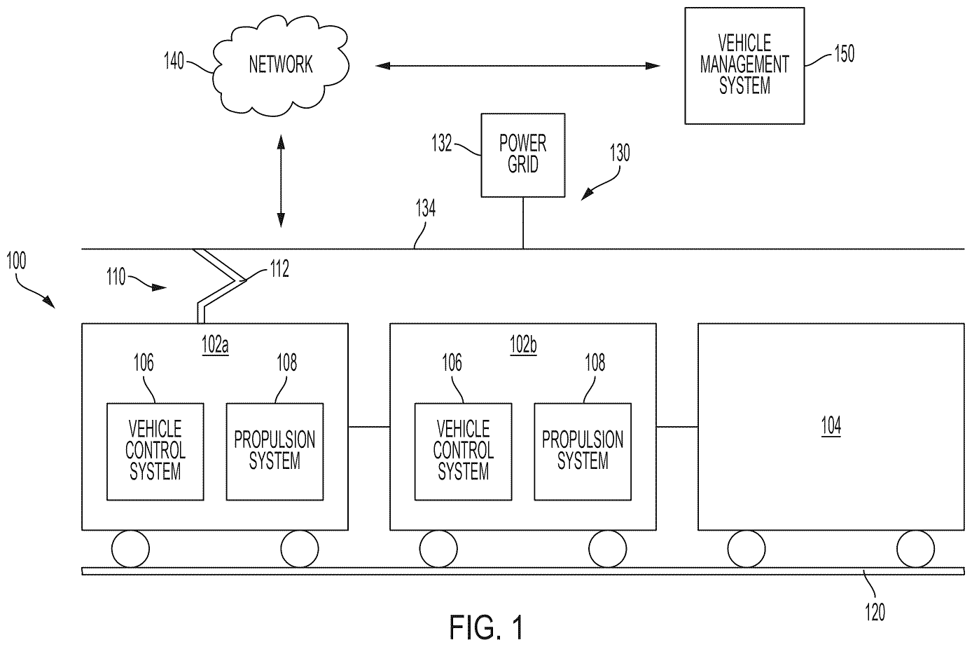

FIG. 1 Illustrates one embodiment of a vehicle system 100. The vehicle system can represent any of the vehicle systems shown and/or described herein. FIG. 1 depicts the vehicle system including a first propulsion generating vehicle 102a, a second propulsion generating vehicle 102b, and one non-propulsion generating vehicle 104. Other embodiments of the vehicle system may include one propulsion generating vehicle or more than two propulsion generating vehicles and may or may not include one or more than one non-propulsion generating vehicle. Each propulsion generating vehicle may be a locomotive (e.g., a battery electric locomotive, a diesel locomotive) while each non-propulsion generating vehicle may be a rail car, and the vehicle system is shown as a train.

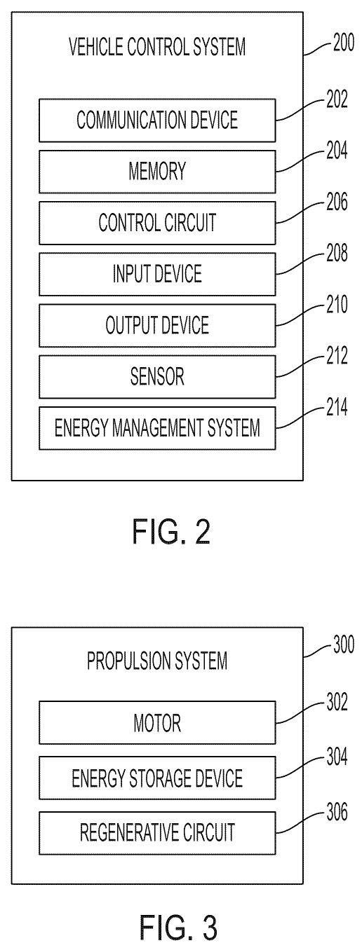

Each of propulsion generating vehicle may include a vehicle control system 106. A suitable vehicle control system may include a control circuit. The vehicle control system may control or limit movement of the corresponding propulsion-generating vehicle and/or the vehicle system along a route 120 based on one or more limitations. For example, the vehicle control system may prevent the vehicles and/or the vehicle system from entering a restricted area, may prevent the vehicle and/or vehicle system from exiting a designated area, may prevent the vehicle and/or vehicle system from traveling at a speed that exceeds an upper speed limit, may prevent the vehicle and/or vehicle system from traveling at a speed that is less than a lower speed limit, may slow or prevent the vehicle and/or vehicle system from traveling according to a designated trip plan. An example of a vehicle control system is discussed further with respect to FIG. 2.

The vehicle control system may be communicatively and/or operably connected with a vehicle management system 150. The vehicle control system and the vehicle management system may be connected via a network 140. A suitable vehicle management system may include a control circuit. The vehicle management system may be disposed offboard the vehicle system or onboard the vehicle system. The vehicle management system can represent any of the vehicle management systems described herein. The vehicle management system may manage movement and/or operational settings of the vehicle system by communicating instructions (e.g., signals) to the vehicle control system. The vehicle management system may be communicatively and/or operably connected with multiple other vehicle systems and may manage movement and/or operational settings of the other vehicle systems, for example, to collectively manage movement and/or operational settings of some or all the connected vehicle systems in aggregate to achieve an operational objective. For example, the vehicle management system may collectively manage movement and/or operational settings to limit, optimize, or otherwise manage an aggregate power consumption of the vehicle systems.

Each of the propulsion generating vehicle includes a propulsion system 108. The propulsion system may provide a tractive effort and/or a braking effort of the corresponding propulsion-generating vehicle. The propulsion system can include one or more of engines, motors, alternators, generators, brakes, energy storage devices, batteries, turbines, fuel cells, fuel systems, and the like. Components of the propulsion system may operate to propel the corresponding propulsion generating vehicle and/or the vehicle system responsive to the vehicle control system. For example, the vehicle control system can direct operations of the propulsion system by the vehicle control system generating control signals autonomously or based at least in part on manual input by an operator.

Referring to the example vehicle system of FIG. 1, the first propulsion generating vehicle and the second propulsion generating vehicle may be the same type of propulsion generating vehicles (e.g., both battery electric vehicles), or the first propulsion generating vehicle and the second propulsion generating vehicle may be the different types of propulsion generating vehicles (e.g., a battery electric vehicle and a combustion engine vehicle). For example, the first propulsion generating vehicle and the second propulsion generating vehicle may have the same type of propulsion system or different types of propulsion systems. Examples of suitable propulsion systems are discussed further with respect to FIGS. 3-5.

The first propulsion generating vehicle and/or the second propulsion generating vehicle may include a conductive circuit 110 to transmit electric energy between the vehicle system and an external power source 130 (e.g., an offboard power sources). For example, as illustrated by FIG. 1, the conductive circuit may include a current collector 112 (e.g. a pantograph), and the external power source may include a power grid 132 (e.g., an electric power network) and a catenary 134 connected to the power grid. The current collector may transmit electrical energy between the vehicle system and the catenary connected to the power grid. In other embodiments, the conductive circuit may include a contact (e.g., a sliding shoe), and the external power source may include a power grid and a rail connected to the power grid (e.g., a third rail). The contact may transmit electrical energy between the vehicle system and the third rail connected to the power grid.

FIG. 2 is a schematic illustration of one embodiment of a vehicle control system 206. The vehicle control system can control the movement of the vehicle system. The vehicle control system can be controlled manually (e.g., by a human operator onboard the vehicle system) and/or autonomously with an energy management system (EMS) 214. For example, an operator onboard the vehicle system may manually control movement of the vehicle system by manually controlling the hardware, controllers, devices, or the like of the vehicle control system. Additionally, or alternatively, the EMS may autonomously control movement of the vehicle system (e.g., without input by an operator onboard the vehicle system) by electrically communicating directions and/or commands to the systems and devices associated with the vehicle control system. A suitable EMS may be Trip Optimizer system, commercially available from Wabtec Corporation.

A suitable EMS can create a trip plan for a trip of the vehicle system and can control aspects of the vehicle system to operate the vehicle according to the trip plan. A trip plan may designate operational settings of the propulsion generating vehicle(s) and/or the vehicle system as a function of one or more of time, location, or distance along a route for a trip. Traveling according to the operational settings designated by the trip plan may reduce electrical power consumed, fuel consumed, and/or emissions generated by the vehicle and/or the vehicle system relative to the vehicle and/or vehicle system traveling according to other operational settings that are not designated by the trip plan. The identities of the vehicle(s) in the vehicle system may be known to the EMS and/or identified by the EMS so that the EMS can control operations of vehicles of the vehicle system. The control may be done autonomously, semi-autonomously, or may be used as guidance so that an operator may control the vehicle according to the trip plan.

Suitable operational settings designated by the trip plan may include a power draw setting, a power return setting, a power source setting, and/or a propulsion source setting. The power draw setting may control a power draw of the vehicle system from the external power source as a function of a location, time, or distance of the vehicle system as the vehicle system travels along a route. A power return setting may control a return of power from the vehicle system to the external power source as a function of a location, time, or distance of the vehicle system as the vehicle system travels along a route. A power source setting may control the vehicle system's propulsion system to use electric energy from an energy storage device onboard the vehicle system or electric energy from the external power source as a function location, time, or distance of the vehicle system as the vehicle system travels along a route. A propulsion source setting may control the vehicle system to utilize an electric motor for propulsion and/or a combustion engine for propulsion as a function of a location, time, or distance of the vehicle system as the vehicle system travels along a route.

The EMS can determine what operational settings to designate for a trip plan to achieve a goal. Suitable goals may for the trip plan include controlling (e.g., reducing) a total power drawn by the vehicle system from the external power source, controlling (e.g., reducing) a peak power draw by the vehicle system from the external power source, controlling (e.g., increasing) a return of power from the vehicle system to the external power source, and/or controlling (e.g., reducing) fuel consumed and/or emissions generated by the vehicle system during the trip. Other suitable goals may include vehicle handling, controlling intra-vehicle forces, arrival time at a destination, and the like.

The vehicle control system may be connected with an input device 208 and an output device 210. A suitable vehicle control system may receive manual input from an onboard operator of the vehicle system through the input device. The input device can include one or more than one device such as a touchscreen, keyboard, electronic mouse, microphone, throttle, pedal, button, and/or other input devices. For example, the vehicle control system can receive manual inputs for changing a tractive effort, braking effort, speed, power output, and the like, from the input device.

The vehicle control system may present information to an operator of the vehicle system using the output device. The output device may include one or more than one device such as a display screen (e.g., touchscreen or other screen), a speaker, a printer, and/or other output devices. For example, the vehicle control system may present the identities and statuses of the vehicle(s) in the vehicle system, identities of missing vehicles (e.g., those vehicles from which the vehicle control system has not received the status), contents of one or more command messages, or the like. The output device may provide a notification signal to the operator of the vehicle system that automatically informs (e.g., notifies) the operator that control of the movement of the vehicle system has changed. Optionally, the output device may present instructions to an operator onboard the vehicle system from the vehicle control system and/or the vehicle management system that instruct the operator how to manually control the movement of the vehicle system. For example, the output device may instruct a throttle notch setting, speed setting, brake setting, power draw setting, power return setting, propulsion source setting, or the like, to the operator of the vehicle system for the operator onboard the vehicle system to manually control the movement of the vehicle system.

The vehicle control system may include or otherwise be coupled to a propulsion system. Examples of suitable propulsion systems are discussed further with respect to FIGS. 3-5. Components of the propulsion system may operate to propel the propulsion generating vehicle and/or the vehicle system responsive to the vehicle control system.

The vehicle control system includes a control circuit 206 that may receive signals from the input device and/or the EMS and based at least in part on the signals from the input device and/or the EMS, the control circuit can control settings of the propulsion system to control movement of the vehicle system. The vehicle control system further may include a memory 204 and a communication device 202. The communication device may include or represent hardware and/or software that is used to communicate with other vehicles in the vehicle system and/or communicate with the vehicle management system via the network. For example, the communication device may include a transceiver and associated circuitry for wirelessly communicating linking messages, command messages, reply messages, repeat messages, or the like. Optionally, the communication device includes circuitry for communicating messages over a wired connection, such as an electric multiple unit (eMU) line of the vehicle system, catenary or third rail for electrically powered vehicles, or another conductive pathway between or among the vehicles of the vehicle system and/or between or among vehicles of a different vehicle system.

The vehicle control system may control the communication device by activating the communication device. The vehicle control system may examine the messages that are received by a communication device from the vehicle management system and/or other vehicles in the vehicle system.

The vehicle control system may include or otherwise be connected with one more than one sensor 212 and can include software and/or circuitry that include and/or are connected with one or more processors. The sensor can be an object detection sensor. The sensor can obtain sensor data that is indicative of an area outside of the vehicle system. For example, the sensor may obtain sensor data in an area in front of the vehicle system relative to a direction of travel of the vehicle system, in an area behind the vehicle system relative to a direction of travel of the vehicle system, or the like. The sensor may include a camera that obtains still and/or motion visual data of an area of the route in the direction of travel of the vehicle system and/or in a direction opposite the direction of travel of the vehicle system. For example, the sensor can include one or more than one camera that captures still images in the front (e.g., in the direction of travel) and the rear (e.g., opposite the direction of travel) of the vehicle system. Optionally, the sensor may include a radar system that sends and receives pulses reflected off of an object in order to detect a presence and/or location of an object in an area outside of the vehicle system. Optionally, the sensor may be an alternative sensing system that obtains data of an area outside of the vehicle system.

FIG. 3 is a schematic illustration of one embodiment of a propulsion system 300. The propulsion system includes a motor 302, an energy storage device 304, and a regenerative circuit 306. The motor can convert energy stored by the energy storage device and/or energy received from the external power source to provide a tractive effort for moving the vehicle system. A suitable motor may include one or more than one electric motor. A suitable energy storage device may include a battery or a supercapacitor. The regenerative circuit can convert energy produced by the vehicle system (e.g., kinetic energy converted during braking, thermal energy (heat) from the motor, brakes, etc.) to electric energy via one or more generators and/or the motor. The regenerative circuit and/or the energy storage device may transmit electrical power from the vehicle system to the external power source via the conductive circuit. The propulsion system of FIG. 3 may be suitable for a battery electric locomotive.

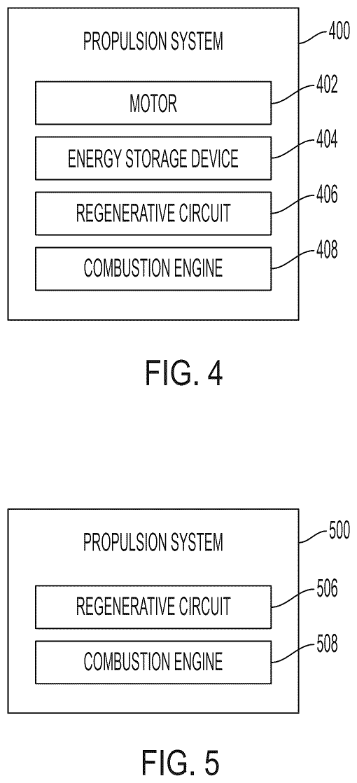

FIG. 4 is a schematic illustration of one embodiment of a propulsion system 400. The propulsion system includes a motor 402, an energy storage device 404, and a regenerative circuit 404, which may be similar to those described with respect to FIG. 3. The propulsion system further includes a combustion engine 408. A suitable combustion engine may include one or more than one diesel engine. The combustion engine can provide a tractive effort for moving the vehicle system. The motor and the combustion engine may operate together to provide a tractive effort. For example, the combustion engine may be coupled to a generator of the regenerative circuit, and the generator may provide electric energy to the motor (e.g., traction motors). As another example, the motor and the combustion engine may operate in parallel to provide the tractive effort. As another example, the combustion engine and the electric motor may operate individually to separately provide the tractive effort at different times. The propulsion system of FIG. 4 may be suitable for a diesel-electric locomotive or a hybrid locomotive.

FIG. 5 is a schematic illustration of one embodiment of a propulsion system 500. The propulsion system includes a combustion engine 508 and may include a regenerative circuit 506, which may be similar to those described with respect to FIG. 3 or 4. A vehicle system induing a first propulsion generating vehicle having the propulsion system of FIG. 3 and a second propulsion generating vehicle having the propulsion system of FIG. 5 may be suitable for an electro-diesel multiple unit train.

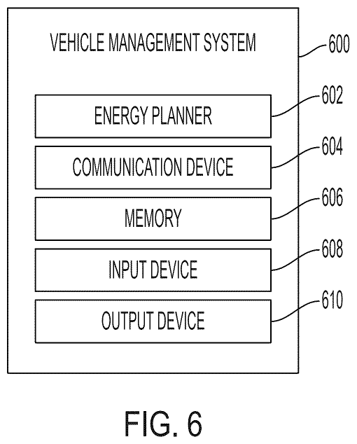

FIG. 6 is a schematic illustration of one embodiment of vehicle management system 600. The vehicle management system includes a communication device 604, an energy planner 602, a memory 606, an input device 608, and an output device 610. The input device can include one or more than one device such as a touchscreen, keyboard, electronic mouse, microphone, button, and/or other input devices. The output device can include one or more than one device such as a display screen (e.g., touchscreen or other screen), a speaker, a printer, and/or other output devices. The communication device can include or represent hardware and/or software that is used to communicate the vehicle control system of one or more vehicle systems via the network. For example, the communication device may include a transceiver and associated circuitry for wirelessly communicating linking messages, command messages, reply messages, repeat messages, or the like. Via the communication device, vehicle management system may receive information related to the current and/or planned movement and operation of vehicle systems. The vehicle management system, via the output device, can present statuses of the vehicle system(s) based on the received information.

The information received by vehicle management system may include information corresponding to trip plans of the vehicle systems. Each of the trip plans may include operational settings such as a power draw setting corresponding to a power draw of the respective vehicle system from the external power source as a function of a location of the vehicle system on the route, a power return setting corresponding to a return of power from the vehicle system to the external power source as a function of the location of the vehicle system on the route, and/or a power source setting for operating an electric motor using electric energy from an energy storage device or electric energy from an external power source as a function of the location of the vehicle system on the route.

The vehicle management system includes an energy planner 602. The energy planner may predict an expected load on the eternal power source based at least in part on the information related to the current and planned movement and/or operation of the vehicle systems. For example, the energy planner may determine the collective expected load on the eternal power source by the vehicle systems as a function of time, and the energy planner may identify when an expected peak load is expected to occur.

The energy panner may generate modifications to the planned movement and/or operation of the vehicle system(s) based at least in part on the expected load on the eternal power source, for example, to achieve an operational objective. In one example, the operational objective may include ensuring that the peak load on the eternal power source at a given time does not exceed a peak load threshold. If the energy panner determines that the expected peak load will exceed the peak load threshold, the energy panner may generate one or more modifications to the trip plan(s) the vehicle system(s) to reduce the expected peak load. The one or more modifications to the trip plans may include changing a power draw setting such that a vehicle system does not draw power from the power grid during a time of the expected peak load. The one or more modifications to the trip plans may include changing a power return setting such that a vehicle system returns power the power grid during a time of the expected peak load. The one or more modifications to the trip plans may include modifying (e.g., pacing, delaying, slowing) the planned movement of a vehicle system, thereby modifying when the vehicle system draws power from the power grid (e.g., so it is not during the time of the expected peak load) and/or modifying a quantity of electricity energy the vehicle system draws from the power grid based on the vehicle system's tractive effort (e.g., so the quantity is reduced during the time of the expected peak load).

The modification(s) to the planned movement and/or operation of the vehicle systems generated by the energy planner may be provided as recommendations to an operator (e.g., a dispatcher) via the output device. The operator may use the input device to send instructions to the vehicle control system of one or more vehicle systems for implementing the modification(s). For example, the instructions to the vehicle control system of one or more vehicle systems may be presented to an operator of the one or more vehicle systems via an onboard output device and the onboard operator may manually implement the modification(s).

The modification(s) to the planned movement and/or operation of the one or more vehicle systems generated by the energy planner may be provided as control signals sent to the vehicle control system of the one or more vehicle systems for automatically modifying the trip plan, thereby automatically modifying the planned movement and/or operation of the corresponding vehicle system(s).

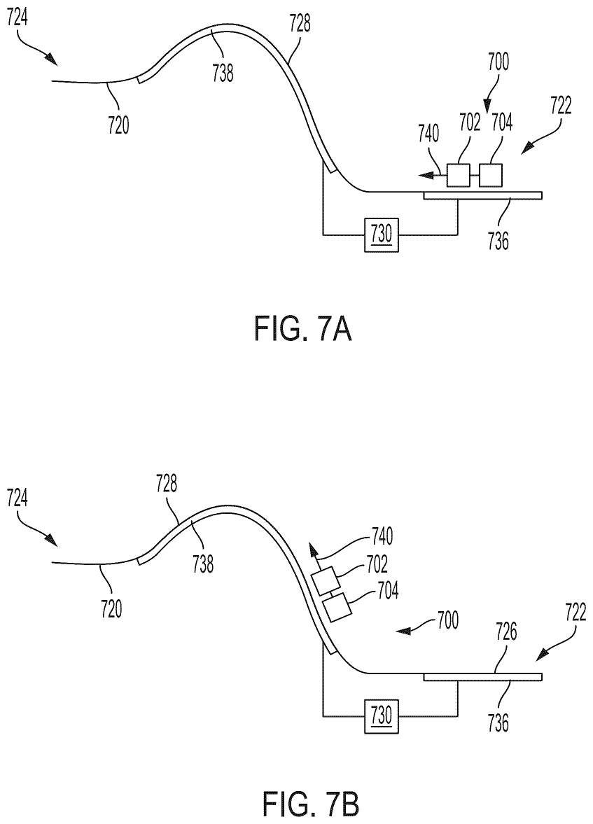

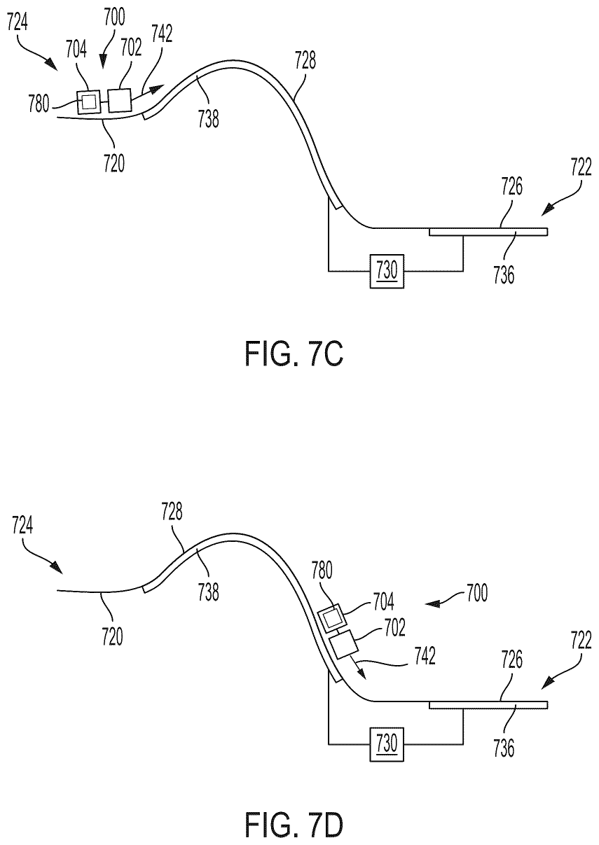

FIGS. 7A-7D illustrate an example a vehicle system 700 moving along a route 720 according to a trip plan. The vehicle system includes one or more than one propulsion generating vehicle 702 and may include one or more than one non-propulsion generating vehicle 704. The trip plan designates operational settings of the vehicle system for moving between a first location 722 and a second location 724 along the route.

Portions of the route may be enabled for transmission of electric energy between an external power source 730 and the vehicle system (e.g., island electrification). As illustrated by FIGS. 7A-7D, a first portion 726 of the route corresponds with a first catenary 736 for transmission of electrical energy between the external power source and the vehicle system and a second portion 728 of the route corresponds with a second catenary 738 for transmission of electrical energy between the external power source and the vehicle system.

The trip plan may designate a power draw setting indicating one or more than one predetermined location along the route where the vehicle system is to draw power from the external source. The trip plan may designate a power return setting indicating one or more than one predetermined location along the route where the vehicle system is to return power to the external power source. The trip plan may designate a power source indicating locations along the route where the vehicle system's propulsion system is to use electric energy from an energy storage device onboard the vehicle system or electric energy from the external power source. The trip plan may designate a propulsion source setting indicating locations along the route where the vehicle system's propulsion is to utilize an electric motor for propulsion and/or a combustion engine for propulsion, for example, if the vehicle system is an electro-diesel multiple unit train and/or includes a hybrid locomotive.

The operational settings of the trip plan may be designed achieve one or more than one operational goal. For example, the operational settings may minimize net power transfer from the external power source to the vehicle system (e.g., or even achieve a negative net power transfer from the external power source to the vehicle system, where the vehicle system returns more power to the external power source than it draws during the trip). The operational settings, for example where the vehicle system includes a combustion engine and an electric motor, may optimize the combustion fuel consumption and power draw from the external power source to optimize (e.g., reduce, minimize) the net combustion fuel and/or electric power costs for the trip. The operational settings may avoid any instantaneous power draw from the external power source exceeding a power draw threshold (e.g., to avoid higher energy costs when the power draw threshold is exceeded). The operational settings may control the vehicle system such that power is drawn from the external power source at times when at least some other vehicles are not drawing power from the external power source (e.g., to avoid higher energy costs when the collective power drawn by multiple vehicle systems exceeds a threshold).

The example of FIGS. 7A-7D illustrates the vehicle system operating according to a trip plan designed to minimize net power transfer from the external power source to the vehicle system. Referring to FIG. 7A, starting the trip, the vehicle system moves in a first direction 740 along the route. The one more than one non-propulsion generating vehicle of the vehicle system may not be carrying a load.

Referring to FIG. 7B, the vehicle system continues along the route in the first direction and enters an inclined portion 760 of the route such that the vehicle system is traveling uphill. The inclined potion of the route overlaps with the first portion of the route that corresponds with the first catenary for transmission of electrical energy between the external power source and the vehicle system. The power transmission setting of the trip plan may cause the vehicle system to selectively draw power from the external power source while traveling uphill at one or more than one location along the overlapping inclined portion and first portion of the route.

Referring to FIG. 7C, the vehicle system reaches the second location along the route and the one or more than one non-propulsion generating vehicle is loaded with cargo. The vehicle system travels in a second direction 742 to travel back towards the first location.

Referring to FIG. 7D, as the vehicle travels again along the inclined portion of the route overlapping with the first portion of the route, this time downhill and with a heaver weight due to the cargo, the trip plan may cause the vehicle system to selectively return power to the external power source. For example, the heaver load and downhill travel of the vehicle system may result in the vehicle system being more efficient in power regeneration. Thus, with a goal of minimizing net power transfer from the external power source to the vehicle system, the trip plan may designate this segment of the trip for power return to rather than power draw from the grid. The vehicle system continues in the second direction to the first location along the route. In some instances, the trip plan may cause the vehicle system to achieve a net negative power transmission, where the vehicle system returns more energy to the external power source than it draws.

FIGS. 7A-7D illustrate just one example of how operational settings can be designated by a trip plan to achieve an operational goal. Those of ordinary skill in the art will appreciate that a predetermined trip plan may designate operational settings for a trip involving a much more complex route, with varying terrain, different stops, varying amounts of cargo load to achieve various operational goals that an inexperienced operator or even an experienced operator manually controlling settings of the vehicle system may not be capable of achieving.

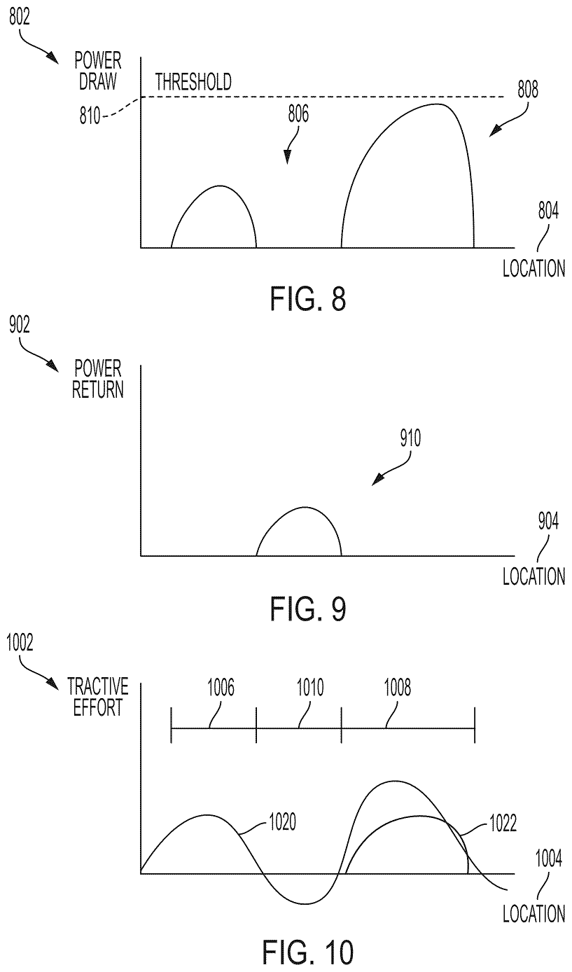

FIG. 8 an example plot 800 of a power draw 802 of a vehicle system from an external power source as a function of a location 804 of the vehicle system on a route, according to one embodiment. The plot may correspond to a power draw setting designated by a trip plan for the vehicle system. As the vehicle move along the route, the vehicle system may begin to draw power from the external power source and then stop drawing power at a first set of locations, corresponding to a first portion 806 of the plot. As the vehicle system continues to move along the route, the vehicle system may again begin to draw power from the external power source and then stop drawing power at a second set of locations, corresponding to a second portion 808 of the plot. The vehicle system draws power at a higher magnitude at the second set of locations compared to the first set of locations. For example, the second set of locations may correspond to a portion of the trip where the vehicle system's tractive effort is higher (e.g., an uphill portion). The trip plan may designate the power draw setting such that the magnitude of power drawn from the external power source by the vehicle at the second set of locations does not exceed a power draw threshold. For example, as discussed with respect to FIG. 10, a propulsion source setting designated by the trip plan may cause a combustion engine of the vehicle system to supplement the tractive effort of the electric motor of the vehicle system to maintain the power draw of the motor from the external power source below the power draw threshold. As an alternative, the power draw setting designated by the trip plan may be a function of time or distance as the vehicle system moves along the route rather than as a function of location.

FIG. 9 is an example plot 900 of a power return 902 of a vehicle system from an external power source as a function of a location 904 of the vehicle system on a route, according to one embodiment. The plot may correspond to a power draw setting designated by a trip plan for the vehicle system. Trip plan may correspond to the same trip plan as discuss above with respect to the plot of FIG. 8. As the vehicle move along the route, the vehicle system may begin to return power to the external power source and then stop returning power at a third set of locations, corresponding to a third portion 910 of the plot. For example, the third set of locations may correspond to a portion of the trip where the vehicle system is able to regenerate power (e.g., via regenerate breaking during a downhill portion of the route). As another example, the third set of locations may correspond to a portion of the trip where the trip plan has designated returning power to the grid (e.g., from an onboard energy storage device) to achieve an operational goal. As an alternative, the power return setting designated by the trip plan may be a function of time or distance as the vehicle system moves along the route rather than as a function of location.

FIG. 10 is a plot of tractive effort 1002 of different propulsion sources a vehicle system as a function of a location 1004 of the vehicle system on a route, according to one embodiment. The plot may correspond to a propulsion source setting designated by a trip plan for the vehicle system. Trip plan may correspond to the same trip plan as discuss above with respect to the plots of FIGS. 8 and 9. As the vehicle move along the route, the vehicle system may primarily utilize a first propulsion source corresponding to an electric motor, as shown by the plot line 1020. The tractive effort output by the first propulsion source may increase and decrease at a first set of locations, corresponding to a first portion 1006 of the plot, may further decrease and then increase at a third second of locations, corresponding to a third portion 1010 of the plot, and may further increase starting at a second set of locations, corresponding to a second portion 1008 of the plot. The trip plan may cause a second propulsion source corresponding to a combustion engine to supplement the tractive effort of the first propulsion source, as shown by the plot line 1022. For example, the second propulsion source may provide a tractive effort to supplement the first propulsion source to avoid exceeding a power draw threshold, as discussed above with respect to FIG. 8. As an alternative, the power return setting designated by the trip plan may be a function of time or distance as the vehicle system moves along the route rather than as a function of location. As another alternative, the trip plan may designate a combustion engine to provide the primary tractive effort and may supplement with the tractive effort of an electric engine, for example, for improved combustion fuel efficiency.

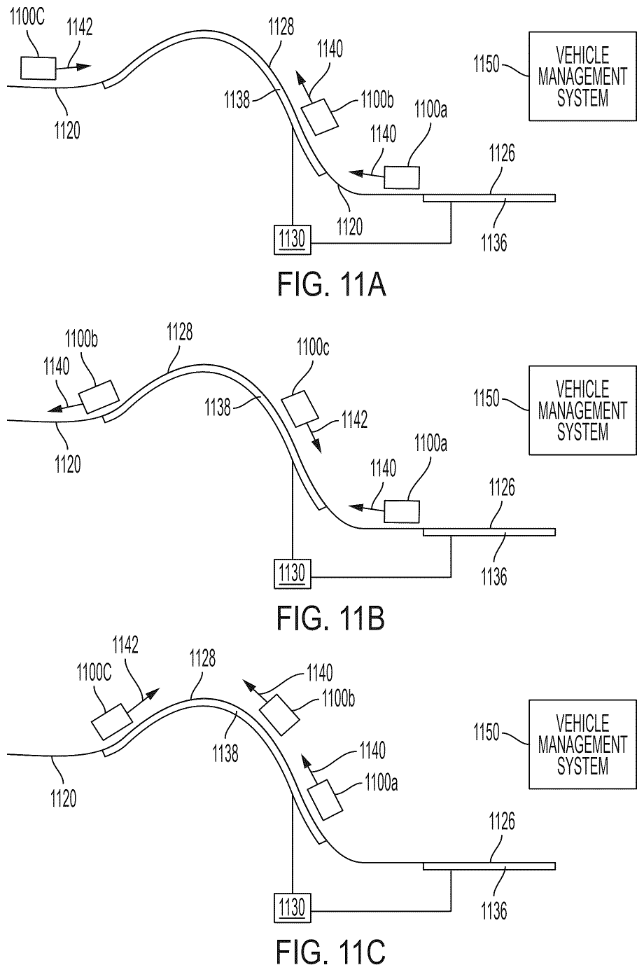

FIGS. 11A-11C illustrate a plurality of vehicle systems moving a route 1120 based at least in part on panned movements and/or operations from a vehicle management system 1150, according to one embodiment. The plurality of vehicle systems includes a first vehicle system 1100a, a second vehicle system 1100b, and a third vehicle system 1100c. Portions of the route may be enabled for transmission of electric energy between an external power source 1130 and the vehicle systems. A first portion 1126 of the route corresponds with a first catenary 1136 for transmission of electrical energy between the external power source and the vehicle system and a second portion 1128 of the route corresponds with a second catenary 1138 for transmission of electrical energy between the external power source and the vehicle system.

Referring to FIG. 11A, the first vehicle system, the second vehicle system, and the third vehicle system a moving along the route according to a first trip plan, a second trip plan, and a third trip plan, respectively. The vehicle management system is in communication with the first vehicle system, the second vehicle system, and the third vehicle system. The vehicle management system may be tracking the current and planned movement and operations of the vehicle systems. For example, the vehicle systems may respectively communicate information corresponding to the trip plans vehicle management system.

The vehicle management system may predict a collective expected load on the external power source as a function of time based at least in part on the trip plans. For example, as shown in FIG. 11A, the first vehicle system is moving in a first direction 1140 towards the second portion of the route but is not currently drawing power from the external power source. The second vehicle system is moving in the first direction on the second portion of the route and may be currently drawing power from the external power source. The third vehicle system is moving in a second direction 1142 towards the second portion of the route but is not currently drawing power from the external power source. The vehicle management system may determine current power draw from the external power source based at least in part on this information.

The vehicle management system may further predict an expected power draw from the external power source based at least in part on the planed movements of the vehicle systems derived from the trip plans. The expected power draw from the external power source may be represented as a set of instantaneous collective power draw values as a function of a set of times. For example, the trip plans may indicate that each of the first vehicle system, the second vehicle system, and the third vehicle system will be moving along the second portion of the route and drawing power from the external power source during a set of times in the future (e.g., as shown by FIG. 11C). The trip plans may further indicate the amount of power that each vehicle system is expected to draw from the external power source (e.g., based on an expected tractive effort of the vehicle systems), and may therefore calculate the expected aggregate power draw by the vehicle systems for each of the times in the set.

The vehicle management system may generate one or more modifications to the trip plans based on the expected power draw from the external power source. For example, the vehicle management system may compare the calculated expected cumulate power draw by the vehicle systems at each future time to a power draw threshold. If the expected cumulate power draw by the vehicle system at one or more of the future times exceeds the power draw threshold, the vehicle management system may generate one or more modifications to the trip plans to cause the expected aggregate power draw from the external power source at each future time to remain below power draw threshold. Such action by the vehicle management system may therefore avoid being charged by a power utility provider a premium energy rate associated with exceeding the power draw threshold.

An example modification to one or more than one trip plan that the vehicle management system may generate based on the expected power draw includes modifying the planned movement of one or more of the vehicle systems. For example, referring to FIG. 11B, the vehicle management system may generate a modification to the trip plan of the first vehicle system. The modification can cause the first vehicle system to pace (e.g. slow) its planned movement such that it does not arrive at the second portion of the route until the second vehicle system is no longer on the second potion of the route. Accordingly, the first vehicle system and the second vehicle system will not be on the second portion of the route at any of the same times, thereby reducing the cumulate power draw from the external power source by preventing the each of the first vehicle system, second vehicle system, and third vehicle system from drawing power at the same times.

An example modification to one or more than one trip plan that the vehicle management system may generate based on the expected power draw includes modifying the power draw setting and/or power return setting of one or more of the vehicle systems. For example, referring to FIG. 11C, the vehicle management system may generate a modification to the trip plan of the first vehicle system. The modification can cause the first vehicle system not draw power from the external power source when it reaches the second portion of the route (e.g., at least until the first vehicle system is no longer on the second portion of the route). Additionally, or alternatively, the modification can cause the first vehicle system to return power to the external power source when it reaches the second portion of the route. Accordingly, the modification may reduce the cumulate power draw from the external power source by preventing the each of the first vehicle system, second vehicle system, and third vehicle system from drawing power at any of the same times and/or by causing the first vehicle system to return power to the external power source.

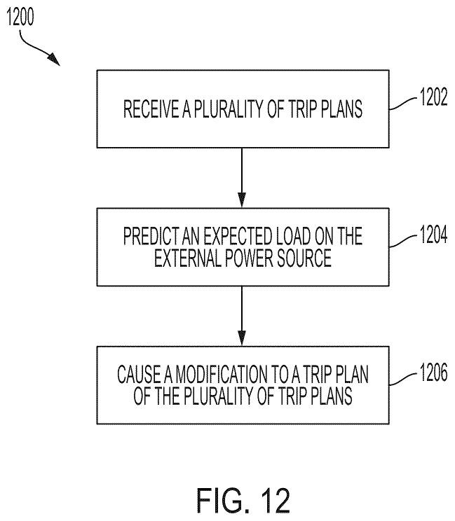

FIG. 12 illustrates a flow diagram of a method 1200 for coordinating movement of a plurality of vehicle systems, according to one embodiment. According to the method, each of the plurality of vehicle systems comprises a vehicle capable of receiving electric energy from an external power source during movement.

Still referring to FIG. 12, according to the method, a control circuit (e.g., of vehicle management system, of a vehicle control system) receives 1202 a plurality of trip plans corresponding to the plurality of vehicle systems. For example, for each vehicle system, a vehicle control system associated therewith may transmit information corresponding to a trip plan to the control circuit. Each trip plan of the plurality of trip plans may include a planned movement of the corresponding vehicle system along a route. The trip plans may further include operational settings of the corresponding vehicle system as a function of time, distance, or location as the vehicle travels along the route.

Still referring to FIG. 12, according to the method, the control circuit predicts 1204 an expected load on the external power source based at least in part on the plurality of trip plans. For example, the expected load may be an aggregate load on the external power source by the vehicle systems as a function of time. The control circuit may identify an expected peak load from the expected load on the external power source as a function of time. The expected peak load may be identified for a specific time or times in the future. The control circuit may further determine whether expected peak load exceeds a peak load threshold.

Still referring to FIG. 12, according to the method, the control circuit causes 1206 a modification of a trip plan of the plurality of trip plans based at least in part on the expected load on the external power source. For example, the control circuit can cause the modification of the trip plan based on determining that the expected peak load exceeds the peak load threshold. In one example, causing the modification to the trip plan may include causing the vehicle system corresponding to the trip plan to change a planned movement along the route to reduce the expected peak load. In another example, causing the modification to the trip plan may include causing the vehicle system corresponding to the trip plan to transmit electric energy from an energy storage device of the vehicle system to the external power source at a time corresponding to the expected peak load. In yet another example, causing the modification to the trip plan may include causing the vehicle system corresponding to the trip plan to not draw energy from the external power source at a time corresponding to the expected peak load. In yet another example, causing the modification to the trip plan may include causing the vehicle system corresponding to the trip plan to draw less energy from the external power source at a time corresponding to the expected peak load by supplementing tractive effort with a combustion engine.

The foregoing description presents various embodiments of systems and processes through block diagrams, flowcharts, and examples. Each of the depicted components, functions, or operations may be implemented using hardware, software, firmware, or combinations thereof. Specific features can be executed using integrated circuits, computer programs, or processors (e.g., microprocessors, microcontrollers), as well as other software-hardware combinations. The design and development of such implementations, whether via circuitry or software, are within the technical expertise of those skilled in the art. Moreover, the described methods and mechanisms may be distributed as program products on various media, with no restriction on the format of the medium.

Instructions for implementing these features can be stored in various types of memory, including dynamic random-access memory (DRAM), flash memory, and/or cache. These instructions can also be distributed over a network or via other computer-readable media. The term “non-transitory computer-readable medium” refers to any physical medium capable of storing or transmitting instructions or information that can be read by a machine. Examples include, but are not limited to, optical disks, CD-ROMs, RAM, ROM, EPROM, EEPROM, magnetic or optical cards, flash memory, or even propagated signals such as carrier waves or infrared signals.

Software components described herein may be implemented using languages such as Python, Java, C++, or Perl. The corresponding software code may be stored on various computer-readable media, such as RAM, ROM, hard drives, or CD-ROMs. These media may be part of a single computational device or distributed across multiple devices within a networked system.

The term “control circuit” encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and are commonly found in devices such as computers, smartphones, and servers. These circuits may perform tasks involving data processing, communication, or data storage.

In some embodiments, the control circuit can utilize machine learning (ML) techniques to make decisions based on sensor inputs or other data. ML methods may include supervised learning (with labeled inputs and outputs), unsupervised learning (for identifying patterns), or reinforcement learning (where the system adapts based on feedback). tasks for ML systems may involve classification, regression, clustering, anomaly detection, or optimization, with algorithms such as decision trees, deep learning, support vector machines (SVMs), or neural networks being employed, depending on the application.

A control circuit may also incorporate a policy engine that applies specific rules based on equipment characteristics or environmental conditions. For instance, a neural network could process sensor data or operational inputs to determine appropriate actions. techniques such as backpropagation or evolutionary strategies may be used to refine neural network parameters and optimize model selection for the given task.

The system may handle data generation, transmission, and storage, potentially leveraging both protected and exposed data sources. Encryption and decryption can be applied during data transit, at rest, or in use, with keys and schemas determined based on operational needs. The control circuit may monitor and enforce decision boundaries, ensuring that data from protected sources meets safety or operational thresholds. If data breaches these boundaries, the system may initiate actions such as equipment shutdown, component isolation, or transitioning to safe mode to mitigate potential risks or damages.

In one embodiment, the control circuit, controller, and systems described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

In one embodiment, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model is selected, and the control circuit can execute that plan to achieve the desired input data to mirror the predicted best outcome scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

The term “logic” refers to software, firmware, and/or circuitry configured to execute the described operations. Logic may be implemented as applications, software packages, instruction sets, or data stored on non-transitory computer-readable storage media. Firmware may be hard-coded into memory devices. Components and modules described herein may be hardware, software, or a combination thereof, and may be in active, inactive, or standby states depending on system requirements.

An “algorithm” refers to a sequence of steps designed to achieve a specific result. These steps may manipulate physical quantities, typically in the form of electrical or magnetic signals, which are represented as bits, values, symbols, or numbers. The terms used to describe these processes are labels for the underlying physical operations.

The system may operate over a packet-switched network using various communication protocols, including Ethernet (complying with IEEE 802.3 standards), X.25, frame relay, or Asynchronous Transfer Mode (ATM). Communication between devices may follow established protocols such as TCP/IP or new emerging standards.

Terms such as “processing,” “computing,” “calculating,” or “determining” refer to operations carried out by computing systems or electronic devices, which manipulate data represented as physical (electronic) quantities within memory or registers.

Terms like “component,” “system,” and “module” refer to computer-related entities, whether hardware, software, or a combination thereof. One or more components may be described as “configured to,” “configurable to,” “operable/operative to,” “adapted/adaptable to,” or similar terms. Unless explicitly stated, these terms encompass components in both active and inactive states.

Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

In summary, various embodiments have been described to illustrate the principles and applications of the disclosed systems and methods. These descriptions are not intended to limit the scope of the invention, and variations may be made by those skilled in the art. The accompanying claims define the invention's broadest legal scope within its spirit and scope.

What is claimed is:

1. A vehicle system including at least one battery electric vehicle, comprising:
a conductive circuit configured to transmit electric energy between the at least one battery electric vehicle and an external power source during movement of the vehicle system;
an electric motor configured to propel the at least one battery electric vehicle using electric energy; and
a control circuit configured to control movement of the vehicle system along a route according to a trip plan, wherein the trip plan comprises operational settings, and wherein the operational settings comprise a power draw setting corresponding to a power draw of the vehicle system from the external power source as a function of a location of the vehicle system on the route.

2. The vehicle system of claim 1, wherein the external power source comprises a power grid, and wherein the conductive circuit comprises a current collector configured to transmit electric energy between the at least one battery electric vehicle and a catenary connected to the power grid.

3. The vehicle system of claim 1, further comprising:
a regenerative circuit coupled to the conductive circuit, wherein the regenerative circuit is configured to generate electric energy from movement of the vehicle system, and wherein the operational settings further comprise a power return setting corresponding to a return of power from the vehicle system to the external power source as a function of the location of the vehicle system on the route.

4. The vehicle system of claim 3, further comprising:
an energy storage device configured to store electric energy, wherein the electric motor is further configured to propel the vehicle system using electric energy from the energy storage device, and wherein the operational settings comprise a power source setting for operating the electric motor using electric energy from the energy storage device or electric energy from the external power source as a function of the location of the vehicle system on the route.

5. The vehicle system of claim 4, wherein the power source setting is configured to operate the electric motor using electric energy from the energy storage device based at least in part on a power requirement of the electric motor exceeding a power requirement threshold.

6. The vehicle system of claim 4, wherein the trip plan is configured to control a total power draw of the vehicle system from the external power source as the vehicle system moves along the route.

7. The vehicle system of claim 4, wherein the trip plan configured to control a peak power draw of the vehicle system from the external power source as the vehicle system moves along the route.

8. The vehicle system of claim 4, wherein the vehicle system further comprises at least one combustion engine vehicle comprising an engine configured to propel the vehicle system using combustion energy, wherein the operational settings comprise a propulsion source setting for operating the electric motor of the at least one battery electric vehicle or the engine of the combustion engine vehicle as a function of the location of the vehicle system on the route.

9. The vehicle system of claim 8, wherein the propulsion source setting comprises operating the electric motor of the at least one battery electric vehicle and the engine of the combustion engine vehicle at a first location the vehicle system on the route, wherein the first location corresponds to an uphill portion of the route.

10. A method for coordinating movement of a plurality of vehicle systems, wherein at least one vehicle in each of the plurality of vehicle systems comprises a battery electric locomotive configured to receive electric energy from an external power source during movement of the at least one vehicle system, the method comprising:
receiving, by a control circuit, a plurality of trip plans corresponding to the plurality of vehicle systems, wherein each trip plan of the plurality of trip plans comprises a planned movement of the corresponding vehicle system along a route;
predicting, by the control circuit, an expected load on the external power source as a function of time based at least in part on the plurality of trip plans; and
causing, by the control circuit, a modification of a trip plan of the plurality of trip plans based at least in part on the expected load on the external power source.

11. The method of claim 10, further comprising:
identifying, by the control circuit, an expected peak load from the expected load on the external power source as a function of time.

12. The method of claim 11, further comprising:
determining, by the control circuit, the expected peak load exceeds a peak load threshold, wherein causing the modification of the trip plan based at least in part on the expected load on the external power source comprises causing the modification of the trip plan based at least in part on the expected peak load.

13. The method of claim 12, wherein causing the modification of the trip plan comprises causing, by the control circuit, the vehicle system corresponding to the trip plan to change a planned movement along the route to reduce the expected peak load.

14. The method of claim 12, wherein causing the modification of the trip plan comprises causing, by the control circuit, the vehicle system corresponding to the trip plan to transmit electric energy from an energy storage device of the vehicle system to the external power source at a time corresponding to the expected peak load.

15. A vehicle system comprising a battery electric vehicle and a combustion engine vehicle, the vehicle system comprising:
a conductive circuit configured to transmit electric energy between the battery electric vehicle and an electric power network during movement of the vehicle system;
an electric motor configured to propel the battery electric vehicle;
a combustion engine configured to propel the combustion engine vehicle; and
a control circuit configured control movement of the vehicle system along a route according to a trip plan, wherein the control circuit is configured to modify the trip plan as a function of the location of the vehicle system on the route to adjust a planned power transmission between the battery electric vehicle and an electric power network as the vehicle system moves along the route.

16. The vehicle system of claim 15, wherein the vehicle system comprises a plurality of vehicle systems each having a battery electric vehicle and a combustion engine vehicle and an offboard server configured to manage movement of the plurality of vehicle system.

17. The vehicle system of claim 16, wherein the trip plan comprises a propulsion source setting for operating at least one of the electric motor and the combustion engine as a function of a location of the vehicle system on the route, and wherein the control circuit is configured to modify the propulsion source setting of the trip plan to adjust power transmission between the battery electric vehicle and an electric power network as the vehicle moves along the route.

18. The vehicle system of claim 16, wherein the trip plan comprises a speed setting for controlling a velocity of the vehicle system as a function of a location of the vehicle system on the route, and wherein the control circuit is configured to modify the speed setting of the trip plan to adjust the planned power transmission between the battery electric vehicle and an electric power network as the vehicle moves along the route.

19. The vehicle system of claim 16, wherein the trip plan comprises power transmission setting for controlling transmission of electric energy between the battery electric and electric power network as a function of a location of the vehicle system along the route, and wherein the control circuit is configured to modify the power transmission setting of the trip plan to adjust the planned power transmission between the battery electric vehicle and an electric power network as the vehicle moves along the route.

20. The vehicle system of claim 16, wherein the trip plan configured to control a power draw of the vehicle system from the electric power network as the vehicle system moves along the route.
